(19) United States
(12) Patent Application Publication
(10) Pub. No.: US 2025/0340393 A1
(43) Pub. Date: Nov. 6, 2025

(54) PAPER ROLL SUPPORT DEVICE, PAPER ROLL CHUCK, AND DEVICE FOR MANUFACTURING CARDBOARD SHEET

(71) Applicant: MITSUBISHI HEAVY INDUSTRIES MACHINERY SYSTEMS, LTD., Kobe-shi, Hyogo (JP)

(72) Inventors: Toshinao OKIHARA, Hyogo (JP); Kazushi KUROTANI, Hyogo (JP); Takahiro HASHIGUCHI, Houston, TX (US)

(21) Appl. No.: 18/851,066

(22) PCT Filed: Feb. 14, 2023
(86) PCT No.: PCT/JP2023/005032

§ 371 Date: Sep. 26, 2024

Related U.S. Application Data
(60) Provisional application No. 63/331,392, filed on Apr. 15, 2022.

(51) Int. Cl. B65H 16/06; B31F 1/20; B65H 16/02

(52) U.S. Cl. CPC B65H 16/06; B31F 1/20; B65H 16/023; B65H 2301/41346; B65H 2301/41358; B65H 2301/4139; B65H 2801/84

(57) ABSTRACT

A support device includes: two support arms movably supported along an axial direction; a driver causing the support arms to approach and separate; and two chucks rotatably mounted on tip portions of the support arms for supporting a paper roll. The chucks include: a main body having an outer diameter decreasing toward a tip portion, and guide parts along the axial direction provided on an outer circumference; and a support members including a receiving part movably supported by the guide parts and for contacting an end of the paper roll, and a support part for contacting an inner circumference of the paper roll. A movement unit includes a movement member for contacting the support members and moves the support members to the tip portion side by the movement member. A force applying device applies force in such a direction that the support members and the movement member approach each other.

### TECHNICAL FIELD

The present disclosure relates to a paper roll support device including a paper roll chuck for supporting a paper roll, a paper roll chuck, and a corrugated board manufacturing apparatus including the paper roll support device.

### BACKGROUND ART

A corrugating machine as a corrugated board manufacturing apparatus includes a single facer and a double facer. The single facer processes a paper tube into a corrugated shape, and bonds a top liner to form a single-faced web. The double facer bonds a bottom liner to the single-faced web to form a double-faced web. The continuous double-faced web manufactured by the double facer is cut into a predetermined width by a slitter scorer, and is cut into a predetermined length by a cutoff device. In this manner, a corrugated board is manufactured.

Each of the single facer and the double facer includes a mill roll stand that supports a paper roll. The mill roll stand rotatably supports the paper roll such as the paper tube, the top liner, and the bottom liner. The mill roll stand includes a pair of arms. The pair of arms is supported to be freely close to and separated from a frame, and a chuck is provided in a tip portion of each of the arms. When the pair of arms are brought closer, each chuck is inserted into a paper tube of the paper roll to nip and support the paper roll.

The chuck includes a chuck body and a plurality of support members. The chuck body has a conical shape, and a plurality of guide portions along an axial direction are provided in an outer peripheral portion. The plurality of support members have an L-shape, and are supported to be movable to each guide portion of the chuck body. Therefore, when the arm moves, a tip portion of the chuck body is inserted into the paper tube of the paper roll, and each support member abuts on an end surface of the paper tube. Each support member moves along the guide portion as the chuck body moves into the paper tube. Then, each support member moves outward of the chuck body, and the outer peripheral portion presses an inner surface of the paper tube to be integrated with the paper tube due to frictional resistance between the outer peripheral portion and the inner surface of the paper tube.

As a paper roll support device having this paper roll chuck, for example, a device disclosed in PTL 1 below is known.

### CITATION LIST

### Patent Literature

[PTL 1] Japanese Examined Utility Model Registration Application Publication No. 7-26280.

### SUMMARY OF INVENTION

### Technical Problem

The paper roll is mounted on a transport carriage, and is transported to the mill roll stand. After the paper roll is loaded to a predetermined position, the arm is lowered, and a center of the paper roll is aligned with a rotation center of the arm (center of the chuck). At this time, the center of the paper roll and the center of the arm may deviate from each other. In this case, when the arm moves and the tip portion of the chuck body is inserted into the paper tube of the paper roll, a phenomenon occurs in which a portion of the support member does not abut on the end surface of the paper tube. Then, when the chuck body is further inserted into the paper tube, the support member which does not abut on the end surface of the paper tube bites into the paper roll, thereby causing damage to a paper roll. In addition, the arm supports the paper roll in an eccentric state where the rotation center deviates from the center of the paper roll. Then, when the chuck is rotated at a high speed and a centrifugal force acts on the paper roll, a load acting on the paper roll during rotation fluctuates, thereby causing a possibility that a feeding web is broken.

The present disclosure is devised to solve the above-described problems, and an object of the present disclosure is to provide a paper roll support device and a corrugated board manufacturing apparatus which suppress damage to a paper roll when a chuck supports the paper roll and suppress support of the paper roll in a state where center deviates from each other.

### Solution to Problem

According to the present disclosure, in order to achieve the above-described object, there is provided a paper roll support device including a pair of support arms supported to be movable along an axial direction of a support shaft of a frame, a drive device that brings the pair of support arms close to and separated from each other, and a pair of chucks rotatably mounted on tip portions of the pair of support arms and configured to support a paper roll. The chuck includes a chuck body having a shape whose outer diameter decreases from a base end portion toward a tip portion and in which a plurality of guide portions along the axial direction are provided on an outer peripheral surface, and a plurality of support members including a receiving portion supported to be movable by the plurality of guide portions and configured to come into contact with an end portion of the paper roll, and a support portion configured to come into contact with an inner peripheral surface of the paper roll. The paper roll support device further comprises a movement unit including a movement member configured to come into contact with the plurality of support members and configured to move the plurality of support members to a tip portion side by the movement member, and a force applying device that applies a force in a direction in which the plurality of support members and the movement member move close to each other.

In addition, according to the present disclosure, there is provided a paper roll chuck including a chuck body having a shape whose outer diameter decreases from a base end portion toward a tip portion and in which a plurality of guide portions along an axial direction are provided on an outer peripheral surface, a plurality of support members including a receiving portion supported to be movable by the plurality of guide portions and configured to come into contact with an end portion of the paper roll, and a support portion configured to come into contact with an inner peripheral surface of the paper roll, and a plurality of connecting members extending from the plurality of support members in a direction intersecting a movement direction of the support member, integrally moving the plurality of support members in the axial direction of the chuck body, and synchronously moving the plurality of support members in a radial direction of the chuck body.

In addition, according to the present disclosure, there is provided a corrugated board manufacturing apparatus including the paper roll support device which supports a paper roll of a first liner, a paper roll of a second liner, and a paper roll of a paper tube serving as a medium, a single facer that manufactures a single-faced web by bonding the second liner to the corrugated medium, and a double facer that manufactures a corrugated board by bonding the first liner to the medium side in the single-faced web.

### Advantageous Effects of Invention

According to a paper roll support device, a paper roll chuck, and a corrugated board manufacturing apparatus of the present disclosure, it is possible to suppress damage to a paper roll when a chuck supports the paper roll, and it is possible to suppress support of the paper roll in a state where centers deviate from each other.

### BRIEF DESCRIPTION OF DRAWINGS

FIG. 1 is a schematic view illustrating a corrugating machine as a corrugated board manufacturing apparatus.

FIG. 2 is a front schematic view illustrating a mill roll stand.

FIG. 3 is a cross-sectional view taken along line III-III in FIG. 2 which illustrates a paper roll support device of a first embodiment.

FIG. 4 is a schematic view illustrating a main part of the paper roll support device.

FIG. 5 is a cross-sectional view illustrating a chuck.

FIG. 6 is a front view illustrating the chuck.

FIG. 7 is a cross-sectional view illustrating a main part of the chuck.

FIG. 8 is a view for describing an operation of a pushing device.

FIG. 9 is a perspective view illustrating an attachment structure of a magnet with respect to a support member.

FIG. 10 is a perspective view illustrating a first modification example of the attachment structure of the magnet with respect to the support member.

FIG. 11 is a perspective view illustrating a second modification example of the attachment structure of the magnet with respect to the support member.

FIG. 12 is a schematic view illustrating a state where the chuck starts to be inserted into a paper roll.

FIG. 13 is a schematic view illustrating a state while the chuck is inserted into the paper roll.

FIG. 14 is a schematic view illustrating a rotation state where the chuck is completely inserted into the paper roll.

FIG. 15 is a cross-sectional view illustrating a main part of a paper roll support device of a second embodiment.

FIG. 16 is a front view illustrating a main part of the paper roll support device.

FIG. 17 is a cross-sectional view illustrating a main part of a paper roll support device of a third embodiment.

FIG. 18 is a cross-sectional view illustrating a main part of a paper roll support device of a fourth embodiment.

FIG. 19 is a front view illustrating the chuck.

FIG. 20 is a front view illustrating an operation of the chuck.

FIG. 21 is a front view illustrating a modification example of the chuck.

### DESCRIPTION OF EMBODIMENTS

Hereinafter, a preferred embodiment of the present disclosure will be described in detail with reference to the drawings. The present disclosure is not limited by the embodiment, and in a case where there are a plurality of embodiments, the present disclosure also includes a configuration in which the respective embodiments are combined with each other. In addition, configuration elements in the embodiment include those which can be easily assumed by those skilled in the art, those which are substantially the same, and those which have a so-called equivalent scope.

### First Embodiment

### <Corrugating Machine>

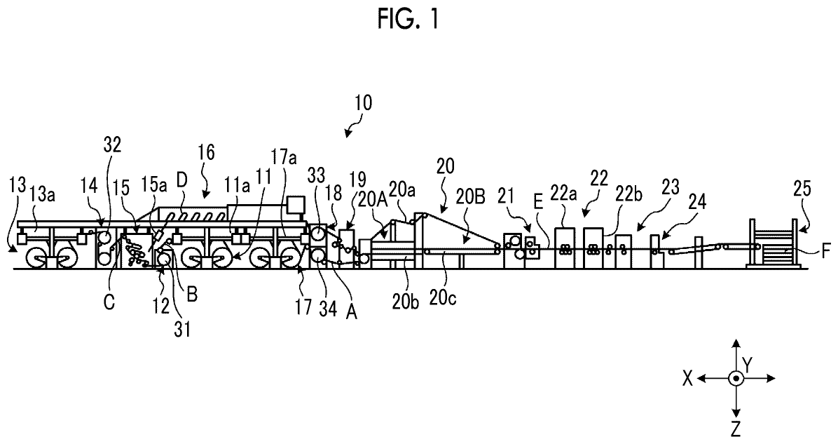

FIG. 1 is a schematic view illustrating a corrugating machine as a corrugated board manufacturing apparatus. In the following description, a front-rear direction in a transfer direction of a corrugated board will be referred to as an X-direction, a horizontal direction orthogonal to the front-rear direction (X-direction) in the transfer direction of the corrugated board will be referred to as a Y-direction (width direction of the corrugated board), and a vertical direction (thickness direction of the corrugated board) orthogonal to the front-rear direction (X-direction) in the transfer direction of the corrugated board will be referred to as a Z-direction.

As illustrated in FIG. 1, a corrugating machine 10 as a corrugated board manufacturing apparatus is used for manufacturing a single-faced web D by bonding a top liner C to a corrugated medium B, manufacturing a double-faced web E by bonding a bottom liner A to the medium B side in the manufactured single-faced web D, and manufacturing a sheet-shaped double-faced web F by cutting the continuous double-faced web E to a predetermined length.

The corrugating machine 10 includes a mill roll stand 11 and a preheater 12 of the medium B, a mill roll stand 13 and a preheater 14 of the top liner C, a single facer 15, a bridge 16, a mill roll stand 17 and a preheater 18 of the bottom liner A, a glue machine 19, a double facer 20, a rotary shear 21, a slitter scorer 22, a cutoff 23, a defective sheet rejecting device 24, and a stacker 25.

In the mill roll stand 11, paper rolls around which the medium B is wound in a roll shape are respectively mounted on both sides in the X-direction, and a splicer 11a which performs paper splicing is provided on an upper side in the Z-direction. When a remaining amount of one paper roll is small, the splicer 11a splices the other paper roll. In this manner, the medium B can be continuously fed toward a downstream side from the mill roll stand 11.

In the mill roll stand 13, the paper rolls around which the top liner C is wound in a roll shape are respectively mounted on both sides in the X-direction, and a splicer 13a which performs paper splicing is provided on the upper side in the X-direction. The other paper roll is spliced by the splicer 13a at a timing at which the remaining amount of the one paper roll is small or at which orders are switched. In this manner, the top liner C can be continuously fed toward the downstream side from the mill roll stand 13.

The preheaters 12 and 14 respectively preheat the medium B and the top liner C. The preheaters 12 and 14 have preheating rolls 31 and 32 into which steam is supplied, and transport the medium B or the top liner C continuously fed from the mill roll stands 11 and 13 while the medium B or the top liner C is heated by the preheating rolls 31 and 32. In this manner, the medium B or the top liner C is heated to a predetermined temperature.

In the single facer 15, the medium B heated by the preheater 12 is corrugated, and thereafter, an adhesive is applied to a top portion of each stage of the medium B. The top liner C heated by the preheater 14 is bonded to the medium B to form the single-faced web D. In the single facer 15, a pick-up conveyor 15a is provided obliquely upward on the downstream side in the transfer direction. The pick-up conveyor 15a is configured to include a pair of endless belts, nips the single-faced web D formed by the single facer 15, and transports the single-faced web D to the bridge 16. The bridge 16 temporarily retains the single-faced web D to absorb a speed difference between the single facer 15 and the double facer 20.

In the mill roll stand 17, the paper rolls around which the bottom liner A is wound in a roll shape are respectively mounted on both sides in the X-direction, and a splicer 17a which performs paper splicing is provided on the upper side. The other paper roll is spliced by the splicer 17a at a timing at which the remaining amount of the one paper roll is small or at which orders are switched. In this manner, the bottom liner A can be continuously fed toward the downstream side from the mill roll stand 17.

The preheater 18 preheats each of the single-faced web D and the bottom liner A. The preheater 18 includes preheating rolls 33 and 34 into which the steam is supplied, and transports the single-faced web D and the bottom liner A continuously fed from the mill roll stand 17 while the single-faced web D and the bottom liner A are heated by the preheating rolls 33 and 34. In this manner, the single-faced web D and the bottom liner A are heated to the predetermined temperature.

The glue machine 19 has an adhesive equipment. The single-faced web D heated by the preheating roll 33 is intermediately guided into the glue machine 19, and an adhesive is applied to each top portion of the stage of the medium B when the single-faced web D passes between a rider roll and an adhesive applicator roll. The single-faced web D to which an adhesive is applied by the glue machine 19 is transferred to the double facer 20. In addition, the bottom liner A heated by the preheating roll 34 is also transferred to the double facer 20 through the inside of the glue machine 19.

The double facer 20 is divided into a heating section 20A on an upstream side and a cooling section 20B on a downstream side along a traveling line of the single-faced web D and the bottom liner A. The single-faced web D to which the adhesive is applied by the glue machine 19 is loaded between a pressurizing belt 20a and a heating plate 20b in the heating section 20A, and the bottom liner A is loaded between the pressurizing belt 20a and the heating plate 20b to overlap the medium B side of the single-faced web D. The single-faced web D and the bottom liner A are loaded between the pressurizing belt 20a and the heating plate 20b, and thereafter, are integrally transferred toward the cooling section 20B in a vertically overlapping state. When transferred, the single-faced web D and the bottom liner A are heated while being pressurized. In this manner, both are bonded to each other to form the continuous double-faced web E. The double-faced web E is naturally cooled when transported while being nipped between the pressurizing belt 20a and a transport belt 20c in the cooling section 20B, and is transferred to the rotary shear 21.

The rotary shear 21 entirely cuts or partially cuts the double-faced web E in a width direction (Y-direction) before bonding is stabilized in an operation initial stage. The slitter scorer 22 cuts the wide double-faced web E along a transfer direction (X-direction) to have a predetermined width, and processes a creasing line extending in the transfer direction. The slitter scorer 22 is configured to include a first slitter scorer unit 22a and a second slitter scorer unit 22b which have substantially the same structure arrayed along the transfer direction of the double-faced web E. The first slitter scorer unit 22a and the second slitter scorer unit 22b have a plurality of sets of upper creasing rolls and lower creasing rolls which are disposed to face each other across the double-faced web E in the width direction, and have a plurality of sets of slitter knives disposed on a lower side of the double-faced web E in the width direction.

The cutoff 23 cuts the double-faced web E cut in the transfer direction by the slitter scorer 22 along the width direction (Y-direction), thereby forming the plate-shaped double-faced web F having a predetermined length. The defective sheet rejecting device 24 discharges the double-faced web F determined to be a defective sheet by a defective sheet detection device from a transport line. The stacker 25 stacks the double-faced webs F having good quality, and discharges the double-faced webs F to the outside of the machine as a product.

### <Mill Roll Stand>

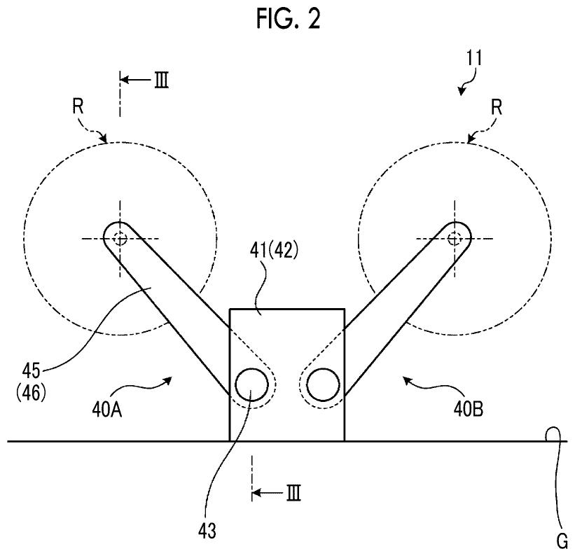

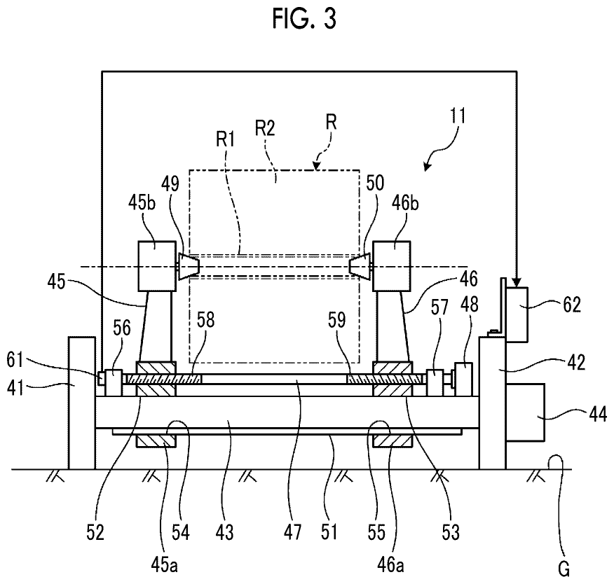

FIG. 2 is a front schematic view illustrating the mill roll stand, and FIG. 3 is a cross-sectional view taken along line III-III in FIG. 2 which illustrates the paper roll support device of the first embodiment. The mill roll stands 11, 13, and 17 have substantially the same configuration. Hereinafter, the mill roll stand 11 will be described, and thus, description of the mill roll stands 13 and 17 will be omitted.

As illustrated in FIG. 2, the mill roll stand 11 includes two of a paper roll support device 40A and a paper roll support device 40B. Each of the paper roll support devices 40A and 40B can rotatably support a paper roll R. Since the paper roll support devices 40A and 40B have the same configuration, the paper roll support device 40A will be described.

### <Paper Roll Support Device>

As illustrated in FIGS. 2 and 3, the paper roll support device 40A includes a pair of frames 41 and 42, a rotary shaft (support shaft) 43, a rotary shaft drive device 44, a pair of support arms 45 and 46, a screw shaft 47, a screw shaft drive device 48, and chucks (paper roll chucks) 49 and 50.

The pair of frames 41 and 42 are installed on a floor surface G at a predetermined interval in the vertical direction. The rotary shaft 43 is disposed along the horizontal direction between the pair of frames 41 and 42, and each end portion in the axial direction is rotatably supported by the pair of frames 41 and 42. The rotary shaft drive device 44 is disposed outside the frame 42, and can rotate the rotary shaft 43. The pair of support arms 45 and 46 are disposed at a predetermined interval between the pair of frames 41 and 42. In the pair of support arms 45 and 46, the first support portions 45a and 46a on a base end portion side are supported by the rotary shaft 43. A key 51 is fixed to an outer peripheral surface of the rotary shaft 43 along the axial direction. In the pair of support arms 45 and 46, support holes 52 and 53 and key grooves 54 and 55 are formed in the first support portions 45a and 46a. In the pair of support arms 45 and 46, the rotary shaft 43 is inserted into the support holes 52 and 53, and the key 51 is fitted to the key grooves 54 and 55. The pair of support arms 45 and 46 can be integrally rotated with the rotary shaft 43 in a circumferential direction, and can move relative to the rotary shaft 43 in the axial direction.

The screw shaft 47 is disposed between the pair of frames 41 and 42 along the horizontal direction. The screw shaft 47 is disposed parallel to the rotary shaft 43. In the rotary shaft 43, a support member 56 is fixed between the frame 41 and the support arm 45, and a support member 57 is fixed between the frame 42 and the support arm 46. Each end portion of the screw shaft 47 in the axial direction is rotatably supported by the support members 56 and 57. In addition, in the screw shaft 47, screw portions 58 and 59 are provided on each end portion side in the axial direction. The screw portions 58 and 59 have a screw formed along a reverse direction. In the screw shaft 47, the screw portion 58 is screwed to the first support portion 45a of the support arm 45, and the screw portion 59 is screwed to the first support portion 46a of the support arm 46. The screw shaft drive device 48 is disposed on an outer peripheral surface in the rotary shaft 43 between the support member 57 and the frame 42, and can rotate the screw shaft 47.

Therefore, when the rotary shaft drive device 44 is driven, the rotary shaft 43 rotates. When the rotary shaft 43 rotates, the support arms 45 and 46 rotate via the key 51 and the key grooves 54 and 55. In addition, when the screw shaft drive device 48 is driven, the screw shaft 47 rotates. When the screw shaft 47 rotates, the support arms 45 and 46 move in the axial direction in synchronization with each other via the screw portions 58 and 59. At this time, the screw portions 58 and 59 are reverse screws. Therefore, when the screw shaft 47 rotates in one direction, the support arms 45 and 46 move close to each other via the screw portions 58 and 59. In addition, when the screw shaft 47 rotates in the other direction, the support arms 45 and 46 are separated from each other via the screw portions 58 and 59.

In the pair of support arms 45 and 46, chucks (paper roll chucks) 49 and 50 are mounted on second support portions 45b and 46b on the other end portion side. The chucks 49 and 50 are mounted on facing surfaces of the second support portions 45b and 46b. The chucks 49 and 50 are attachable to and detachable from the second support portions 45b and 46b.

In addition, a detection sensor 61 is provided in the support member 56. The detection sensor 61 detects a position of the support arm 45 in the axial direction with respect to the frame 41. The detection sensor 61 detects a rotation amount of the screw shaft 47. The detection sensor 61 detects a position of the second support portion 45b in the support arm 45, based on the rotation amount of the screw shaft 47. In the frame 42, an operation control panel (control device) 62 is provided in an upper portion. An operator can drive and control the rotary shaft drive device 44 and the screw shaft drive device 48 by operating the operation control panel 62. In addition, the operation control panel 62 drives and controls the screw shaft drive device 48, based on a detection result of the detection sensor 61. Without being limited to the above-described configuration, for example, the detection sensor 61 may be a distance sensor that detects the position of the second support portion 45b in the support arm 45 with respect to the frame 41.

The paper roll R is obtained by winding a continuous paper R2 having a predetermined length around an outer peripheral portion of a paper-made (or resin-made) paper tube R1. The paper roll R is mounted on a transport carriage (not illustrated), and is transported to a position between the pair of support arms 45 and 46. Here, the support arms 45 and 46 are lowered to align a center of the paper roll R with a rotation center (center of the chuck) of the support arms 45 and 46. The center of the paper roll R and a center of the chucks 49 and 50 substantially coincide with each other. In this state, the screw shaft 47 is rotated by driving the screw shaft drive device 48, and the support arms 45 and 46 are moved to be close to each other. Then, the chucks 49 and 50 mounted on the second support portions 45b and 46b of the pair of support arms 45 and 46 are inserted into the respective end portions of the paper tube R1 of the paper roll R. In this manner, the paper roll R is supported via the paper tube R1.

### <Paper Roll Support Device and Chuck>

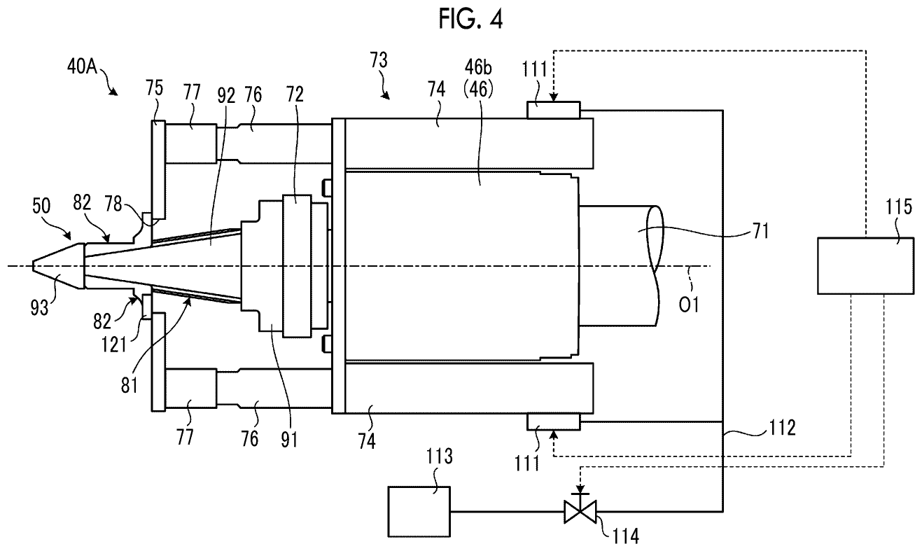

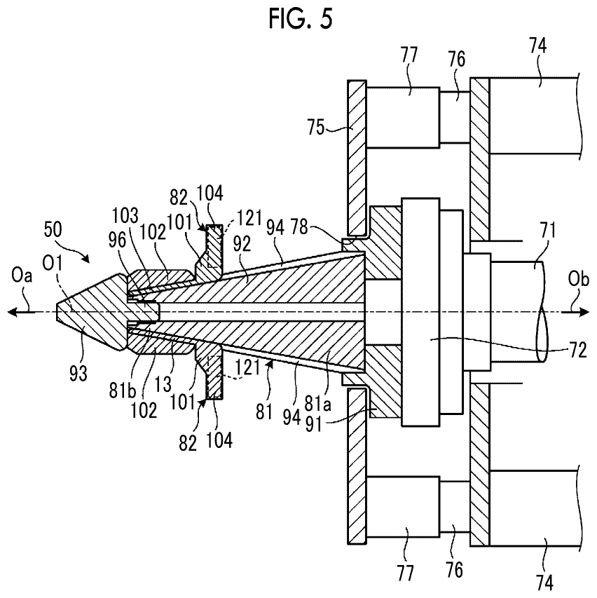

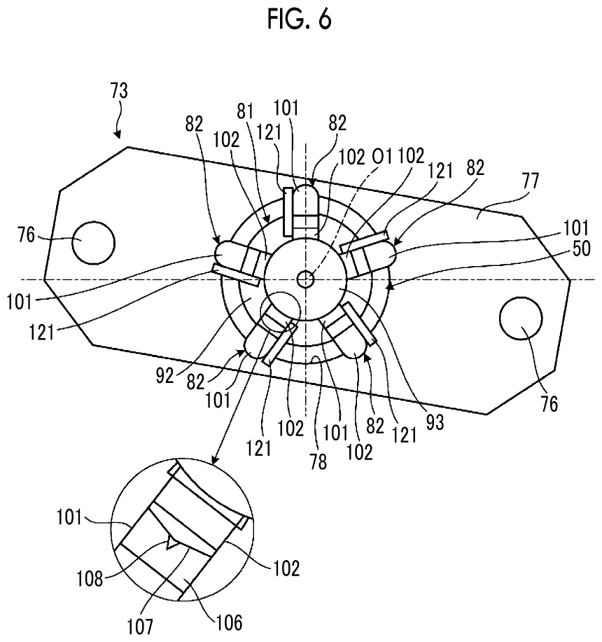

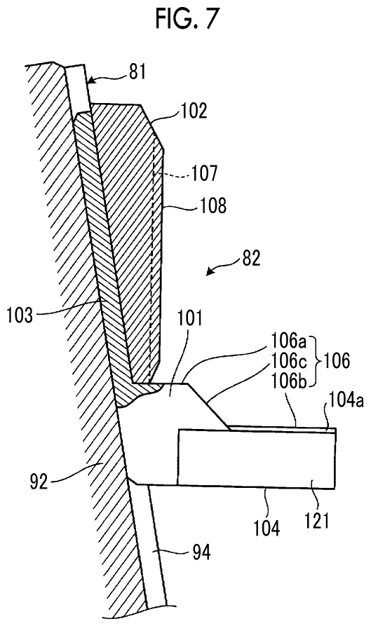

FIG. 4 is a schematic view illustrating a main part of the paper roll support device of the first embodiment, FIG. 5 is a cross-sectional view illustrating the chuck, FIG. 6 is a front view illustrating the chuck, and FIG. 7 is a cross-sectional view illustrating a main part of the chuck. The support arms 45 and 46 and the chucks 49 and 50 have substantially the same configuration, and the support arm 46 and the chuck 50 will be described.

In the following description, the center of the chuck 50 is a center line O1, and the center of the paper roll R is a center line O2. A movement direction of the chuck 50 to the paper roll R is the axial direction of the chuck 50, and is a direction parallel to the center line O1. The radial direction of the chuck 50 is a direction orthogonal to the center line O1, and the circumferential direction of the chuck 50 is a circumferential direction around the center line O1. In addition, an insertion direction of the chuck 50 into the paper roll R is a direction Oa along the center line O1, and a separation direction of the chuck 50 from the paper roll R is a direction Ob along the center line O1.

As illustrated in FIG. 4, in the support arm 46, a rotary shaft 71 is rotatably supported by the second support portion 46b. A rotation drive device (not illustrated) is connected to one end portion of the rotary shaft 71 in the axial direction. The rotation drive device can drive and rotate the rotary shaft 71. The chuck 50 is detachably mounted on the other end portion of the rotary shaft 71 in the axial direction via a connecting member 72. The paper roll support device 40A includes a pushing device (movement unit) 73. The pushing device 73 includes a plurality of (two in the present embodiment) air cylinders 74 and a pushing plate (movement member) 75. The plurality of air cylinders 74 are fixed to the second support portion 46b. The plurality of air cylinders 74 include a rod 76 which can expand and contract in the axial direction. The movement direction of each rod 76 is a direction parallel to the center line O1. A pushing plate 75 is connected to the tip portion of the plurality of rods 76 via a connecting member 77. That is, the rod 76 is connected to each end portion of the pushing plate 75 in a longitudinal direction. The pushing plate 75 is disposed along a direction orthogonal to the center line O1. An opening 78 having a circular shape is formed in a central portion of the pushing plate 75. An inner diameter of the opening 78 is smaller than a minimum outer diameter of a plurality of support members 82 (to be described later) forming the chuck 50.

As illustrated in FIGS. 5 and 6, the chuck 50 includes a chuck body 81 and the plurality of support members 82.

The chuck body 81 has a shape whose outer diameter decreases from the base end portion 81a toward the tip portion 81b, that is, a conical shape as a whole. The chuck body 81 includes an attachment portion 91, a main body part 92, and a stopper portion 93. The attachment portion 91 is mounted on the connecting member 72 of the rotary shaft 71. The attachment portion 91 has a circular plate shape. The main body part 92 has a conical shape along the axial direction (direction of the center line O1). The main body part 92 has a large outer diameter of the base end portion 81a, and an outer diameter of the tip portion 81b is smaller than the outer diameter of the base end portion 81a. The base end portion 81a of the main body part 92 is integrally connected to the attachment portion 91. In this case, the attachment portion 91 and the main body part 92 are integrally molded, but may be separately molded and connected by adhesion or fastening.

The main body part 92 is provided with a plurality of (in the present embodiment, five) guide grooves 94 as a plurality of guide portions. The guide portion is not limited to the guide groove 94, and may be a guide recessed portion or the like. The plurality of guide grooves 94 have the same shape. The number of the guide grooves 94 is not limited to five as long as the number is two or more. The plurality of guide grooves 94 are provided along the axial direction on the outer peripheral surface of the main body part 92. However, since the main body part 92 has a conical shape, the plurality of guide grooves 94 are disposed to be inclined and close to the center line O1 from the base end portion side toward the tip portion side. The plurality of guide grooves 94 are disposed on the outer peripheral surface of the main body part 92 at a predetermined interval (preferably, an equal interval) in the circumferential direction.

The stopper portion 93 has a conical shape along the axial direction. The stopper portion 93 has a large outer diameter of the base end portion, and the outer diameter of the tip portion is smaller than the outer diameter of the base end portion. A maximum outer diameter of the stopper portion 93 is a dimension smaller than a minimum inner diameter of the paper tube R1. The stopper portion 93 is integrally connected to the tip portion of the main body part 92 (tip portion 81b of the chuck body 81). A connecting rod 96 is provided at a center position of the base end portion of the stopper portion 93. In the stopper portion 93, the connecting rod 96 is fixed to the main body part 92. The main body part 92 and the stopper portion 93 are formed separately and connected to each other, but may be integrally formed.

A plurality of (in the present embodiment, five) the support members 82 are provided. The plurality of support members 82 have the same shape. The plurality of support members 82 are supported to be movable by the guide grooves 94 provided in the main body part 92 of the chuck body 81. The number of the support members 82 is not limited to five as long as the number is two or more, and is the same as the number of the guide grooves 94. The plurality of support members 82 move along the guide groove 94. In this manner, the position of the support member 82 in the axial direction with respect to the chuck body 81 is changed, and the position of the support member 82 in the radial direction is changed. Therefore, the outer diameter of the plurality of support members 82, that is, the outer diameter of a circle passing through an outer peripheral position of the plurality of support members 82 is changed. As described above, the inner diameter of the opening 78 in the pushing plate 75 is smaller than the minimum outer diameter when the plurality of support members 82 move to the tip portion 81b.

As illustrated in FIGS. 5 to 7, the support member 82 includes a moving portion 101 and a support portion 102. The moving portion 101 includes an attachment support portion 103 and a flange portion 104. The attachment support portion 103 has a shape along the outer peripheral surface of the main body part 92. The flange portion 104 is connected to an end portion of the attachment support portion 103, and is disposed to protrude outward in the radial direction of the chuck body 81. The support portion 102 has an arc shape along the outer peripheral surface of the main body part 92. In the moving portion 101, the support portion 102 is disposed outside the attachment support portion 103, and is integrally fixed. The moving portion 101 and the support portion 102 are separately fastened to each other, but may be integrally formed. The support member 82 is supported to be movable along the guide groove 94 provided in the main body part 92 of the chuck body 81 by the attachment support portion 103 of the moving portion 101.

The support member 82 has a receiving surface (receiving portion) 106 and a support surface (support portion) 107. The receiving surface 106 is provided in the flange portion 104 of the moving portion 101. The receiving surface 106 is a surface provided on the tip portion 81b side of the chuck body 81 in the flange portion 104, and extending in a direction orthogonal to the center line O1. The receiving surface 106 can come into contact with an end portion of the paper tube R1 of the paper roll R. The support surface 107 is a surface provided outside the chuck body 81 in the radial direction in the support portion 102, and parallel to a direction of the center line O1. The support surface 107 can come into surface contact with an inner peripheral surface of the paper tube R1. The support surface 107 is provided with a protrusion portion 108 protruding outward in the radial direction. The protrusion portion 108 is provided along the axial direction on the support surface 107, and is locked by biting into an inner surface of the paper tube R1 of the paper roll R to support the paper roll R.

In addition, the receiving surface 106 has a first receiving surface (first receiving portion) 106a, a second receiving surface (second receiving portion) 106b, and an inclined surface 106c. The receiving surface 106 is long in the radial direction of the chuck body 81. The first receiving surface 106a is located on the tip portion 81b side which is the center line O1 side of the chuck body 81. The second receiving surface 106b is located on the base end portion 81a side which is the outer side of the chuck body 81 in the radial direction. That is, the second receiving surface 106b is located on the outer peripheral portion side and the base end portion 81a side of the chuck body 81 with respect to the first receiving surface 106a. The inclined surface 106c connects the first receiving surface 106a and the second receiving surface 106b. The first receiving surface 106a, the second receiving surface 106b, and the inclined surface 106c are flat surfaces. However, the inclined surface 106c may be a curved surface that smoothly and continuously connects the first receiving surface 106a, the second receiving surface 106b, and the inclined surface 106c without a step.

An inner diameter of the paper tube R1 of the paper roll R is 3 inches (75 mm) or 4 inches (100 mm) in many cases. When the chuck 50 supports the paper roll R, in a case where the paper tube R1 has the inner diameter of 3 inches, in the plurality of support members 82, the first receiving surface 106a receives and supports the end portion of the paper tube R1. On the other hand, when the chuck 50 supports the paper roll R, in a case where the paper tube R1 has the inner diameter of 4 inches, in the plurality of support members 82, the second receiving surface 106b receives and supports the end portion of the paper tube R1.

The plurality of support members 82 are supported to be movable along each of the guide grooves 94 of the chuck body 81. The movement of the plurality of support members 82 along the guide groove 94 is defined by the attachment portion 91 and the stopper portion 93. When the plurality of support members 82 move toward the tip portion 81b of the chuck body 81, the plurality of support members 82 move in a direction close to the center line O1, and when the plurality of support members 82 move toward the base end portion 81a of the chuck body 81, the plurality of support members 82 move in a direction separated from the center line O1. That is, when the chuck 50 moves in the direction Oa which is the insertion direction to the paper tube R1, the receiving surface 106 comes into contact with and presses the end portion of the paper tube R1. In this manner, the plurality of support members 82 move toward the base end portion 81a of the chuck body 81. Then, the plurality of support members 82 move outward in the radial direction of the chuck 50, and the support surface 107 comes into contact with and presses the inner peripheral surface of the paper tube R1. Therefore, in the chuck 50, the receiving surface 106 presses the end portion of the paper tube R1, the support surface 107 presses the inner peripheral surface of the paper tube R1, and the protrusion portion 108 bites into the inner surface of the paper tube R1 of the paper roll R. In this manner, the chuck 50 supports the paper roll R to be integrally rotatable.

### <Pushing Device>

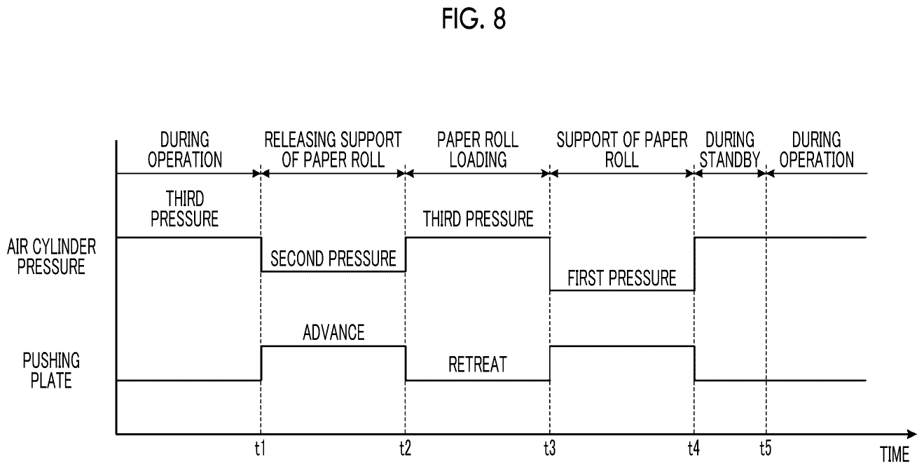

FIG. 8 is a view for describing an operation of the pushing device.

As illustrated in FIG. 4, the pushing device 73 includes the pushing plate 75 that can come into contact with the plurality of support members 82, and the plurality of support members 82 can be moved to the tip portion 81b side of the chuck body 81 by the pushing plate 75. That is, when the chuck 50 supports the paper roll R, the plurality of support members 82 are located on the base end portion 81a side of the chuck body 81. When the chuck 50 releases the support of the paper roll R, the chuck 50 moves with respect to the paper roll R in the direction Ob which is the separation direction from the paper tube R1. Then, the plurality of support members 82 remain located on the base end portion 81a side of the chuck body 81, and the chuck 50 is less likely to support the paper roll R again. Therefore, after the chuck 50 releases the support of the paper roll R, in the pushing device 73, the plurality of support members 82 are moved to the tip portion 81b side of the chuck body 81 by the pushing plate 75.

In addition, when the chuck 50 supports the paper roll R, in the chuck 50, each of the receiving surfaces 106 of the plurality of pressing members presses the end portion of the paper tube R1, and the support surface 107 presses the inner peripheral surface of the paper tube R1. Therefore, when the chuck 50 is moved in the direction Ob which is the separation direction from the paper tube R1, the plurality of support members 82 are less likely to be pulled out from the paper tube R1. Therefore, when the chuck 50 releases the support of the paper roll R, in the pushing device 73, the plurality of support members 82 are pressed to move to the tip portion 81b side of the chuck body 81 by the pushing plate 75.

In the plurality of air cylinders 74, two chambers are partitioned by a piston supported to be movable inside the cylinder. The rod 76 is contracted by supplying air to one chamber and discharging air from the other chamber. In addition, the rod 76 is expanded by supplying the air to the other chamber and discharging the air from the one chamber. A switching device 111 switches between the chamber to which the air is supplied and the chamber from which the air is discharged. The switching device 111 is connected to an air supply source (for example, a factory air source) 113 via an air supply and discharge pipe 112. The air supply and discharge pipe 112 is provided with a flow regulator 114. The flow regulator 114 can adjust the amount (pressure) of air supplied to each chamber via the switching device 111. That is, the flow regulator 114 can adjust a pressing force of the pushing plate 75 via the rod 76 by adjusting the amount of air supplied to the air cylinder 74.

The control device 115 can control the switching device 111 and the flow regulator 114. The control device 115 performs switching control on the switching device 111 and opening/closing control on the flow regulator 114 in accordance with a preset program, an operation command from an operator, or the like. Here, the control device 115 is a controller, and for example, is realized in such a manner that a central processing unit (CPU) or a micro processing unit (MPU) executes various programs stored in a storage unit by using a RAM as a work region.

As illustrated in FIGS. 4 and 8, during an operation of the paper roll support device 40A (mill roll stand 11), the chuck 50 supports the paper roll R, the rod 76 of the air cylinder 74 is contracted by a third pressure, and the pushing plate 75 is located at a retracted position. At time t1, the operation is stopped, and the chuck 50 moves in the direction Ob which is the separation direction from the paper tube R1 to release the support of the paper roll R. At this time, the rod 76 of the air cylinder 74 is expanded by a second pressure, the pushing plate 75 advances, and the pushing plate 75 presses the plurality of support members 82 to move to the tip portion 81b side of the chuck body 81. Therefore, the chuck 50 is easily separated from the paper tube R1, and the support of the paper roll R is released.

When the support of the paper roll R is released by the paper roll support device 40A at time t2, the paper roll R to be used next is loaded. At this time, the rod 76 of the air cylinder 74 is contracted by the third pressure, and the pushing plate 75 is located at the retracted position. When the paper roll R is completely loaded into the paper roll support device 40A at time t3, the rod 76 of the air cylinder 74 is expanded by a first pressure, the pushing plate 75 advances, and the pushing plate 75 moves the plurality of support members 82 to the tip portion 81b side of the chuck body 81. Therefore, in the chuck 50, the paper roll R can be supported by the plurality of support members 82.

The support arms 45 and 46 are moved by the paper roll support device 40A. In this manner, the chuck 50 is inserted into the paper tube R1 of the paper roll R to support the paper roll R. At time t4, the operation reaches a standby state, and at time t5, the operation of the paper roll support device 40A (the mill roll stand 11) starts. For example, the third pressure of the air cylinder 74 is a pressure when an opening degree of the flow regulator 114 is set to 100%. The second pressure is a pressure when the opening degree of the flow regulator 114 is set to 20% to 50%, and is lower than the third pressure. The first pressure is a pressure when the opening degree of the flow regulator 114 is set to 20%, and is equivalent to the second pressure or is lower than the second pressure. The pressure and the opening degree vary depending on the configuration of the pushing device 73 or the like, and are not limited to the above-described numerical values.

That is, the pushing device 73 can press the pushing plate 75 against the plurality of support members 82, and is operated so that the pushing plate 75 advances when the paper roll R is supported by the chuck 50 and when the chuck 50 is separated from the paper roll R. A pressing force with which the pushing plate 75 is pressed against the plurality of support members 82 by the pushing device 73 when the chuck 50 is separated from the paper roll R is equal to a pressing force when the paper roll R is supported by the chuck 50, or a pressing force when the chuck 50 is separated from the paper roll R is higher.

### <Suction Device>

As illustrated in FIGS. 5 and 6, the paper roll support device 40A is provided with a magnet 121 as a force applying device and a suction device. The magnet 121 applies a force (suction force) in a direction in which the plurality of support members 82 and the pushing plate 75 move close to each other. The force (suction force) of the magnet 121 is lower than a support force with which the chuck 50 supports the paper roll R. Specifically, the force (suction force) of the magnet 121 is lower than the support force with which the chuck 50 is separated from the paper tube R1 when the support surfaces 107 of the plurality of support members 82 press the inner peripheral surface of the paper tube R1 of the paper roll R.

The magnet 121 is provided in the plurality of support members 82. The magnet 121 has a rectangular parallelepiped shape, and is disposed on a side surfaces of the plurality of support members 82. That is, as illustrated in FIG. 7, the support member 82 includes the moving portion 101 and the support portion 102, and the moving portion 101 includes the attachment support portion 103 and the flange portion 104. The magnet 121 is fixed to one side surface 104a of the flange portion 104. On the other hand, the pushing plate 75 is a magnetic body, and can be suctioned by the magnet 121 provided in the plurality of support members 82. The magnet 121 has a rectangular parallelepiped shape. However, the shape of the magnet 121 is not limited to this shape. The magnet 121 may have any shape as long as the magnet 121 can suction the pushing plate 75. However, it is preferable to improve mounting performance of the magnet 121 on the pushing plate 75 by setting a surface that comes into contact with the pushing plate 75 as a flat surface shape.

When the chuck 50 moves in the direction Oa which is the insertion direction into the paper tube R1, in the pushing device 73, the pushing plate 75 presses the plurality of support members 82 to the tip portion 81b side of the chuck body 81, and the plurality of support members 82 are located at the position where the support member 82 abuts on the stopper portion 93. At this time, the plurality of support members 82 are suctioned to the pushing plate 75 by the magnet 121. As the chuck 50 is inserted into the paper tube R1, the receiving surface 106 comes into contact with the end portion of the paper tube R1, and the plurality of support members 82 are pressed to move along the guide groove 94 to the base end portion 81a of the chuck body 81. Then, the plurality of support members 82 move outward in the radial direction of the chuck 50, and the support surface 107 comes into contact with and presses the inner peripheral surface of the paper tube R1. That is, the plurality of support members 82 are moved integrally with the pushing plate 75 by the magnet 121.

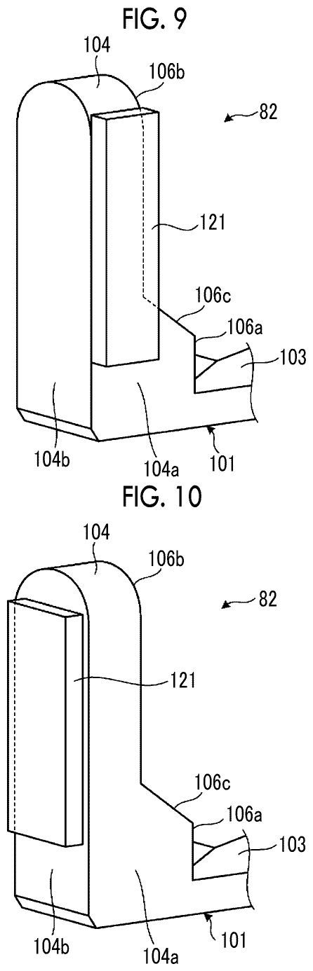

FIG. 9 is a perspective view illustrating an attachment structure of the magnet with respect to the support member.

As illustrated in FIG. 9, the support member 82 includes the moving portion 101, and the moving portion 101 includes the attachment support portion 103 and the flange portion 104. The flange portion 104 is provided with the first receiving surface 106a, the second receiving surface 106b, and the inclined surface 106c, as the receiving surface 106. In addition, the flange portion 104 is provided with a pair of side surfaces 104a orthogonal to the receiving surface 106. Furthermore, the flange portion 104 is provided with a bottom surface 104b on a side opposite to the receiving surface 106. The bottom surface 104b is a surface facing the pushing plate 75 (refer to FIG. 5). The magnet 121 having a rectangular parallelepiped shape is fixed to one side surface 104a of the flange portion 104. In this case, it is preferable that an end surface of the magnet 121 is continuous with the bottom surface 104b of the flange portion 104 without a step. However, the magnet 121 may protrude to the pushing plate 75 side from the bottom surface 104b of the flange portion 104.

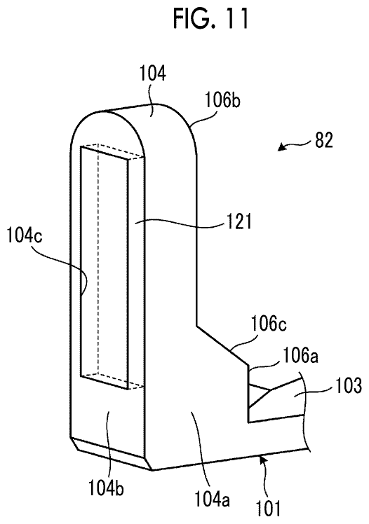

The attachment structure of the magnet 121 with respect to the support member 82 is not limited to the above-described structure. FIG. 10 is a perspective view illustrating a first modification example of the attachment structure of the magnet with respect to the support member, and FIG. 11 is a perspective view illustrating a second modification example of the attachment structure of the magnet with respect to the support member.

As illustrated in FIG. 10, the magnet 121 having a rectangular parallelepiped shape is fixed to the bottom surface 104b of the flange portion 104. In this case, the magnet 121 protrudes to the pushing plate 75 side from the bottom surface 104b of the flange portion 104.

In addition, as illustrated in FIG. 11, the magnet 121 having a rectangular parallelepiped shape is disposed on the bottom surface 104b side in the flange portion 104. The flange portion 104 is provided with a recessed portion 104c having the same shape as the magnet 121 on the bottom surface 104b. The magnet 121 is fixed to be accommodated in the recessed portion 104c. In this case, it is preferable that an end surface of the magnet 121 is continuous with the bottom surface 104b of the flange portion 104 without a step. However, the magnet 121 may protrude to the pushing plate 75 side from the bottom surface 104b of the flange portion 104.

### Method for Supporting Paper Roll by Paper Roll Support Device

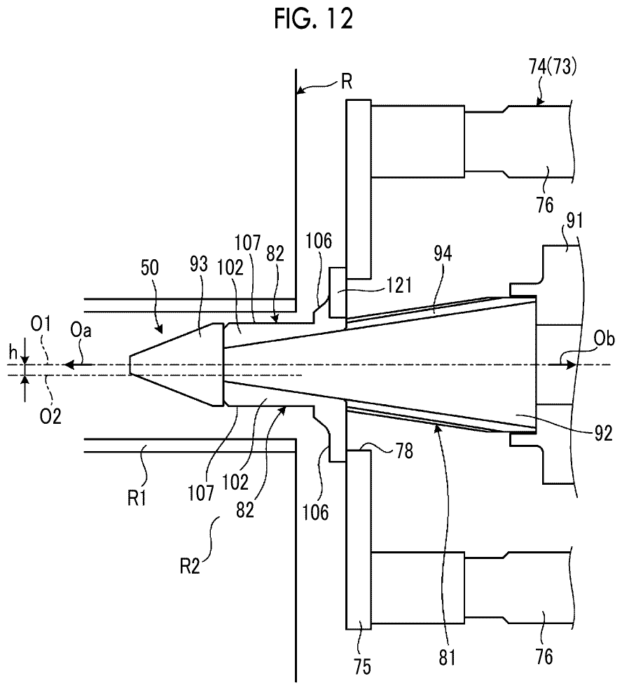

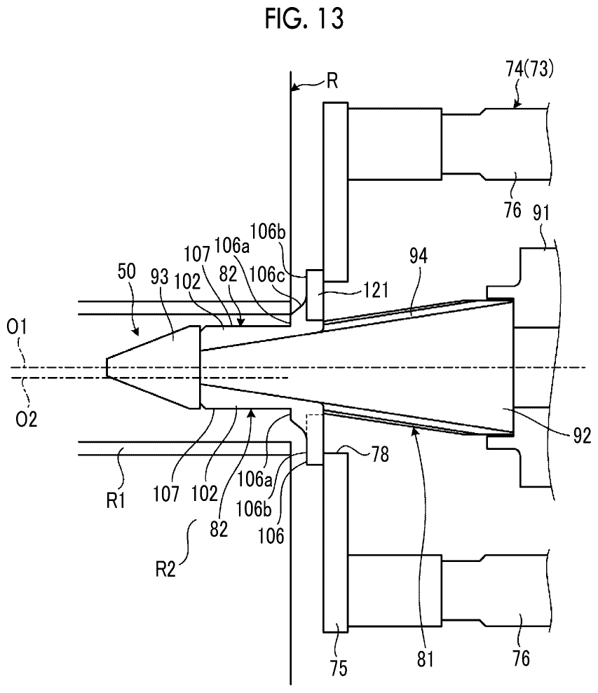

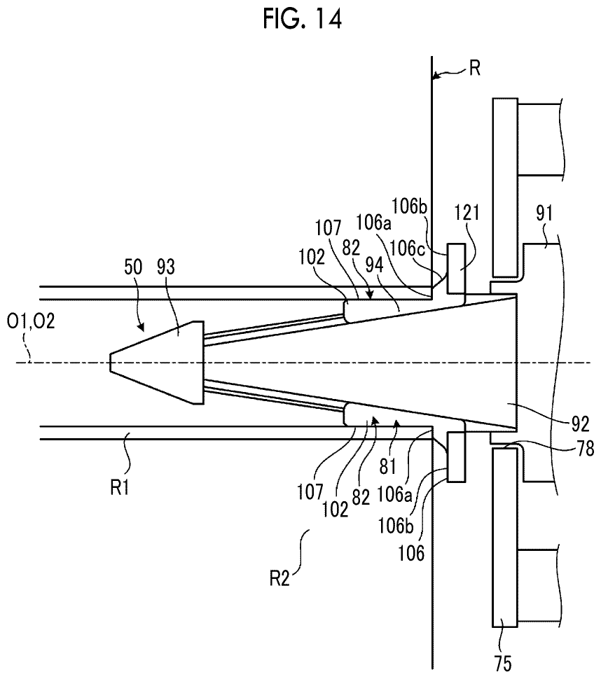

FIG. 12 is a schematic view illustrating a state where the chuck starts to be inserted into the paper roll, FIG. 13 is a schematic view illustrating a state while the chuck is inserted into the paper roll, and FIG. 14 is a schematic view illustrating a rotating state where the chuck is completely inserted into the paper roll.

As illustrated in FIG. 3, the paper roll R is configured so that the continuous paper R2 having a predetermined length is wound around the outer peripheral portion of the paper tube R1. The paper roll R is mounted on a transport carriage (not illustrated) and is disposed between the pair of support arms 45 and 46. The support arms 45 and 46 are lowered, and the paper roll R is aligned with the center (center line O2) of the paper roll R and the center (center line O1) of the chucks 49 and 50. In this state, the screw shaft 47 is rotated by driving the screw shaft drive device 48, and the support arms 45 and 46 are moved to be close to each other. Then, the chucks 49 and 50 mounted on the second support portions 45b and 46b of the pair of support arms 45 and 46 are inserted into the paper tube R1 of the paper roll R to support the paper roll R. Hereinafter, an operation of the chucks 49 and 50 will be described. However, since the chucks 49 and 50 have the same operation, the operation of one chuck 50 will be described in detail.

As illustrated in FIG. 12, the pushing device 73 causes the pushing plate 75 to advance, and moves the plurality of support members 82 in the direction Oa by supplying the air to the plurality of air cylinders 74. The plurality of support members 82 are pressed by the pushing plate 75 to be pressed to a position where the support members 82 abut on the stopper portion 93 of the chuck body 81. In this state, the chuck 50 moves with respect to the paper roll R in the direction Oa which is the insertion direction into the paper tube R1. At this time, the center line O2 of the paper roll R deviates downward from the center line O1 of the chuck 50 by a predetermined height h in the vertical direction.

In this state, when the chuck 50 moves in the direction Oa, in the chuck 50, the stopper portion 93 is first inserted into the paper tube R1, and subsequently, the support portion 102 of the plurality of support members 82 is inserted into the paper tube R1. At this time, the chuck 50 secures a gap between the support surface 107 of each support portion 102 and the inner peripheral surface of the paper tube R1. When the chuck 50 is further moved in the direction Oa, as illustrated in FIG. 13, in the chuck 50, the first receiving surface 106a of the flange portions 104 of the plurality of support members 82 abuts on the end surface of the paper tube R1. However, since the center line O2 of the paper roll R deviates from the center line O1 of the chuck 50 by the predetermined height h, any first receiving surface 106a in the plurality of support members 82 does not abut on the end surface of the paper tube R1, and a gap is generated.

When the chuck 50 continues to move in the direction Oa, the support member 82 in which the first receiving surface 106a abuts on the end surface of the paper tube R1 receives the pressing force from the paper tube R1, and moves in the direction Ob. The support member 82 moves by overcoming the pressing force of the air cylinder 74 via the pushing plate 75. At this time, since all of the plurality of support members 82 are suctioned to the pushing plate 75 by the magnet 121, the plurality of support members 82 move in the direction Ob in synchronization. That is, the support member 82 in which the first receiving surface 106a does not abut on the end surface of the paper tube R1 also moves in the direction Ob by a suction force of the magnet 121. In addition, at this time, the plurality of support members 82 move outward in the radial direction of the chuck 50 while moving in the direction Ob, and the support surfaces 107 moves close to the inner peripheral surface of the paper tube R1.

When the chuck 50 continues to further move in the direction Oa, as illustrated in FIG. 14, the plurality of support members 82 move outward in the radial direction while moving in the direction Ob. Then, in the plurality of support members 82, a gap between the support surface 107 and the inner peripheral surface of the paper tube R1 is reduced, and the support surface 107 comes into contact with the inner peripheral surface of the paper tube R1. At this time, since the plurality of support members 82 uniformly move the respective support surfaces 107 outward in the radial direction, the support surface 107 presses the inner peripheral surface of the paper tube R1, and correct a position of the paper roll R. That is, the paper roll R is pressed upward in the vertical direction by the plurality of support members 82 of the chuck 50, and the center (center line O2) substantially coincides with the center (center line O1) of the chuck 50.

When the chuck 50 supports the paper roll R, all of the receiving surfaces 106 (first receiving surface 106a) of the plurality of support members 82 come into contact with the end surface of the paper tube R1, and all of the support surfaces 107 come into contact with the inner peripheral surface of the paper tube R1. The chuck 50 supports the paper roll R at a position where the center lines O1 and O2 coincide with each other. Therefore, the specific support member 82 does not damage the continuous paper R2 without biting into the paper roll R.

Here, the chuck 50 stops moving in the direction Oa. In the chuck 50, each receiving surface 106 (first receiving surface 106a) of the plurality of support members 82 presses the end surface of the paper tube R1, and each support surface 107 presses the inner peripheral surface of the paper tube R1. Therefore, the chuck 50 supports the paper roll R to be integrally rotatable by frictional resistance between the support surface 107 and the inner peripheral surface of the paper tube R1. At this time, the chucks 49 and 50 support the paper roll R in a concentric manner. Therefore, the paper roll R is not in an eccentric state, and a web of the paper roll R is not broken by a centrifugal force acting during rotation. Thereafter, the pushing device 73 supplies the air to the plurality of air cylinders 74 to cause the pushing plate 75 to retreat. At this time, the pushing plate 75 retreats by overcoming a suction force of the magnet 121, and is separated from the plurality of support members 82.

As illustrated in FIG. 3, the paper roll support device 40A supports the paper roll R to be integrally rotatable by inserting the chucks 49 and 50 mounted on the second support portions 45b and 46b of the pair of support arms 45 and 46 into the paper tube R1 of the paper roll R. The paper roll R is rotatably supported by the pair of support arms 45 and 46 via the chucks 49 and 50.

### Second Embodiment

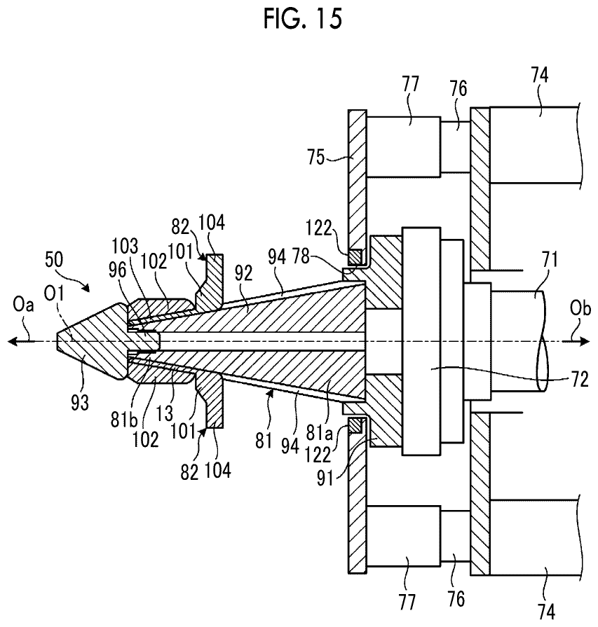

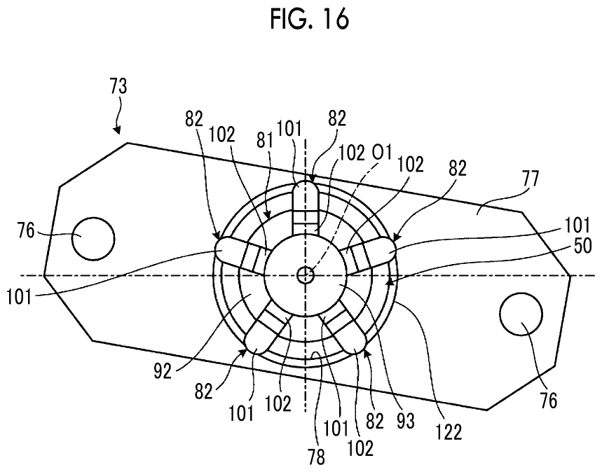

FIG. 15 is a cross-sectional view illustrating a main part of a paper roll support device of a second embodiment, and FIG. 16 is a front view illustrating the main part of the paper roll support device. The same reference numerals will be assigned to members having the same functions as those in the above-described embodiment, and thus, detailed description thereof will be omitted.

As illustrated in FIGS. 15 and 16, the paper roll support device 40A is provided with a magnet 122 as a force applying device and a suction device. The magnet 122 applies a force (suction force) in a direction in which the plurality of support members 82 and the pushing plate 75 move close to each other. The force (suction force) of the magnet 122 is lower than the support force with which the chuck 50 supports the paper roll R. Specifically, the force (suction force) of the magnet 122 is lower than the support force with which the chuck 50 is separated from the paper tube R1 when the support surface 107 of the plurality of support members 82 presses the inner peripheral surface of the paper tube R1 of the paper roll R.

The magnet 122 is provided in the pushing plate 75. The pushing plate 75 is provided with the opening 78 into which the chuck body 81 can be inserted. The magnet 122 is provided along an edge of the opening 78. In the present embodiment, the opening 78 has a circular shape, and the magnet 122 has a ring shape. The magnets 122 are disposed along the inner peripheral surface of the opening 78 in the pushing plate 75. On the other hand, the plurality of support members 82 are formed of a magnetic body, and can be suctioned by the magnet 122 provided in the pushing plate 75. The shape of the magnet 122 is not limited to the above-described shape. The magnet 122 has a ring shape. However, for example, the magnet 122 may have an integral ring shape, or may have a ring shape including a plurality of divided members. In addition, the magnets 122 may be provided at an interval in the circumferential direction in the opening 78 of the opening 78. Furthermore, when the opening 78 has a polygonal shape, the magnets 122 are continuously or discontinuously provided along the edge of the opening 78.

When the chuck 50 moves in the direction Oa which is the insertion direction into the paper tube R1, in the pushing device 73, the pushing plate 75 presses the plurality of support members 82 to the tip portion 81b side of the chuck body 81, and the plurality of support members 82 are located at the position where the support member 82 abuts on the stopper portion 93. At this time, the plurality of support members 82 are suctioned to the pushing plate 75 by the magnets 122. As the chuck 50 is inserted into the paper tube R1, the receiving surface 106 comes into contact with the end portion of the paper tube R1, and the plurality of support members 82 are pressed to move along the guide groove 94 to the base end portion 81a of the chuck body 81. Then, the plurality of support members 82 move outward in the radial direction of the chuck 50, and the support surface 107 comes into contact with and presses the inner peripheral surface of the paper tube R1. That is, the plurality of support members 82 are moved integrally with the pushing plate 75 by the magnets 122.

The operation of the magnet 122 as the force applying device and the suction device are the same as those in the first embodiment, and thus, description thereof will be omitted.

### Third Embodiment

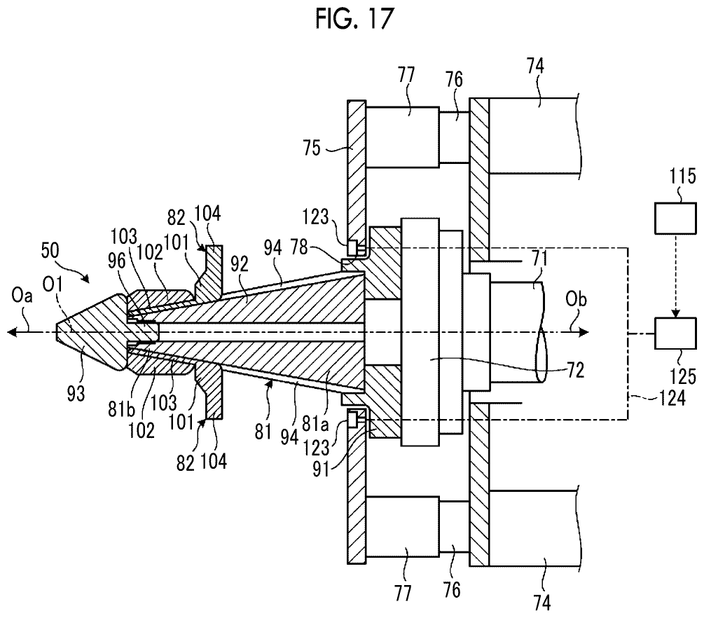

FIG. 17 is a cross-sectional view illustrating a main part of a paper roll support device of a third embodiment. The same reference numerals will be assigned to members having the same functions as those in the above-described embodiment, and thus, detailed description thereof will be omitted.

As illustrated in FIG. 17, the paper roll support device 40A includes a suction portion 123 as a force applying device and a suction device, a suction pipe 124, and a blower (suction device) 125.

The suction portion 123 is a recessed portion that is open on the chuck 50 side, and is provided along a peripheral edge portion of the opening 78 in the pushing plate 75. The suction portion 123 may have a shape that forms a groove shape along the peripheral edge portion of the opening 78 in the pushing plate 75, or may have a shape in which a plurality of recessed portions are provided at an interval along the peripheral edge portion of the opening 78 in the pushing plate 75. The suction portion 123 is connected to the blower 125 via the suction pipe 124. The control device 115 can drive and control the blower 125. When the blower 125 is operated, a suction force (negative pressure) is generated, and the generated suction pressure acts on the suction portion 123 via the suction pipe 124. The suction force of the suction portion 123 is a force in a direction in which the plurality of support members 82 and the pushing plate 75 move close to each other. The suction force of the suction portion 123 is lower than the support force of the chuck 50 that supports the paper roll R. Specifically, the suction force of the suction portion 123 is lower than the support force with which the chuck 50 is separated from the paper tube R1 when the support surface 107 of the plurality of support members 82 presses the inner peripheral surface of the paper tube R1 of the paper roll R. When the suction force of the suction portion 123 is not required, the blower 125 may be stopped.

When the chuck 50 moves in the direction Oa which is the insertion direction into the paper tube R1, in the pushing device 73, the pushing plate 75 presses the plurality of support members 82 to the tip portion 81b side of the chuck body 81, and the plurality of support members 82 are located at the position where the support member 82 abuts on the stopper portion 93. At this time, the control device 115 operates the blower 125 to generate the suction force in the suction portion 123. Then, the plurality of support members 82 are suctioned to the pushing plate 75 by the suction portion 123. As the chuck 50 is inserted into the paper tube R1, the receiving surface 106 comes into contact with the end portion of the paper tube R1, and the plurality of support members 82 are pressed to move along the guide groove 94 to the base end portion 81a of the chuck body 81. Then, the plurality of support members 82 move outward in the radial direction of the chuck 50, and the support surface 107 comes into contact with and presses the inner peripheral surface of the paper tube R1. That is, the plurality of support members 82 are moved integrally with the pushing plate 75 by the suction force of the suction portion 123.

The operations of the suction portion 123 as the force applying device and the suction device, the suction pipe 124, and the blower 125 are the same as those in the first embodiment, and thus, description thereof will be omitted.

### Fourth Embodiment

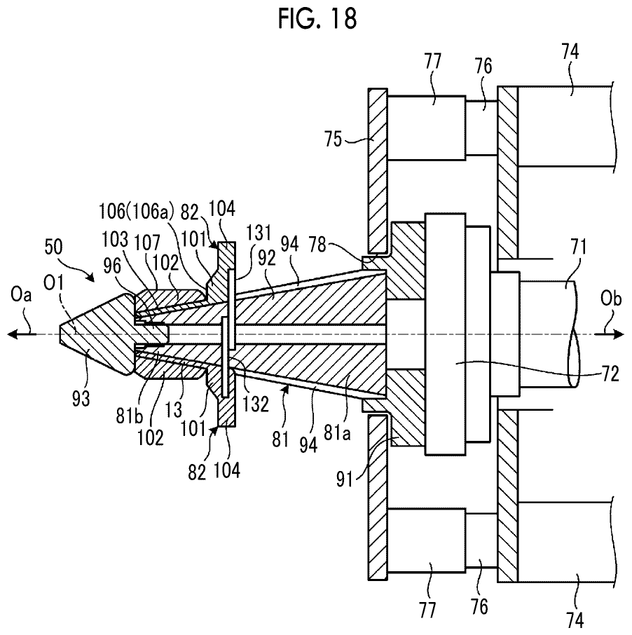

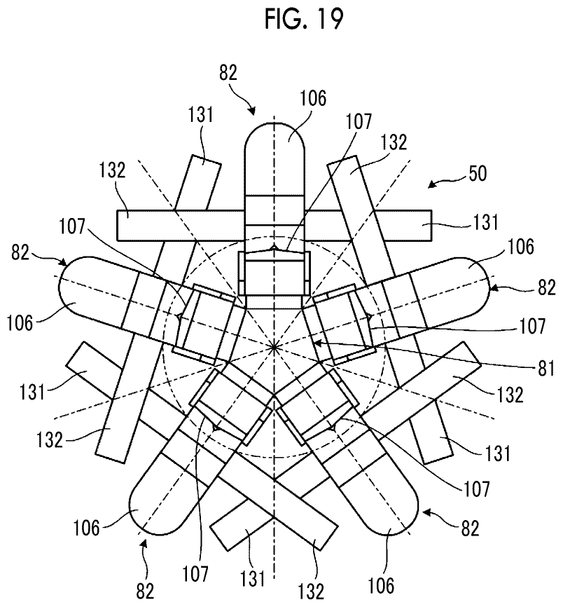

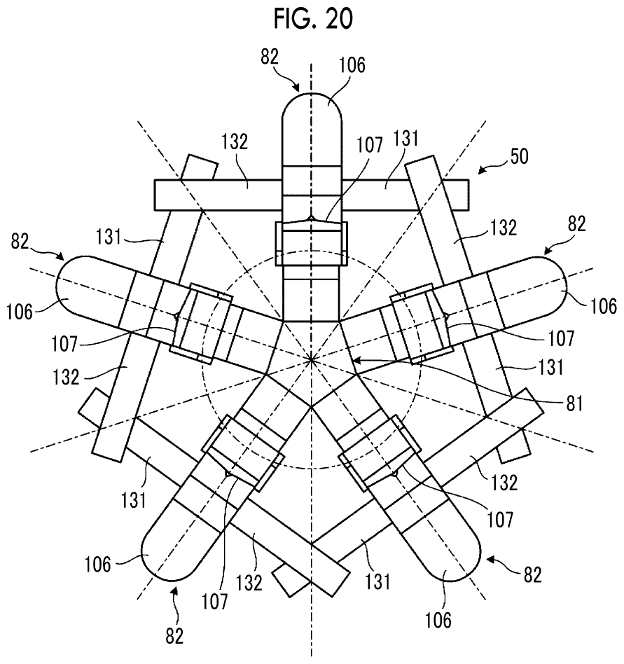

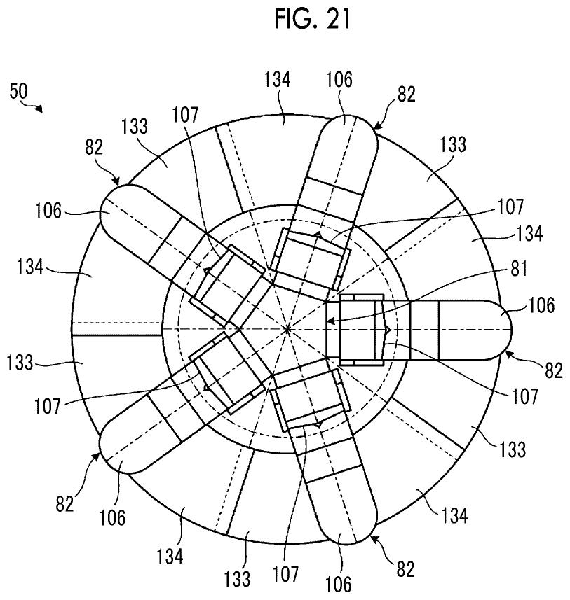

FIG. 18 is a cross-sectional view illustrating a main part of a paper roll support device of a fourth embodiment, FIG. 19 is a front view illustrating the chuck, and FIG. 20 is a front view illustrating an operation of the chuck. The same reference numerals will be assigned to members having the same functions as those in the above-described embodiment, and thus, detailed description thereof will be omitted. In addition, in FIGS. 19 and 20, the stopper portion 93 is illustrated by a two-dot chain line to facilitate understanding of a shape of the chuck.

As illustrated in FIGS. 18 and 19, the chuck 50 includes the chuck body 81 and the plurality of support members 82. The chuck body 81 has a conical shape as a whole. The plurality of guide grooves 94 are provided along the axial direction in the chuck body 81. The plurality of support members 82 are supported to be movable by the guide groove 94 of the chuck body 81. The plurality of support members 82 have the receiving surface 106 and the support surface 107. In the plurality of support members 82, the receiving surface 106 can come into contact with the end surface of the paper tube R1, and the support surface 107 can come into contact with the inner peripheral surface of the paper tube R1.

The chuck 50 includes a first connecting member 131 and a second connecting member 132 as connecting members. The first connecting member 131 and the second connecting member 132 extend from the plurality of support members 82 in a direction intersecting a movement direction of the support members 82 (direction of the center line O1). The first connecting member 131 and the second connecting member 132 integrally move the plurality of support members 82 in the axial direction (direction of the center line O1) of the chuck body 81. At this time, the first connecting member 131 and the second connecting member 132 synchronously move the plurality of support members 82 in the radial direction of the chuck body 81.

Specifically, the first connecting member 131 extends in a direction orthogonal to the side surface from one side surface of each support member 82. The second connecting member 132 extends in a direction orthogonal to the side surface from the other side surface of each support member 82. The first connecting member 131 and the second connecting member 132 are plate members having a rectangular shape. The first connecting member 131 and the second connecting member 132 are disposed to deviate by a predetermined distance in the axial direction (direction of the center line O1) of the chuck body 81. The first connecting member 131 and the second connecting member 132 are disposed to overlap each other in the axial direction of the chuck body 81 between the adjacent support members 82. In the adjacent support members 82, the second connecting member 132 overlaps the first connecting member 131 so that the second connecting member 132 is disposed on the tip portion 81b side of the chuck body 81.

Therefore, as illustrated in FIGS. 19 and 20, the plurality of support members 82 are supported to be movable along each of the guide grooves 94 of the chuck body 81. When the plurality of support members 82 move toward the tip portion 81b of the chuck body 81, the plurality of support members 82 move in a direction close to the center line O1. At this time, in the plurality of support members 82, the first connecting member 131 and the second connecting member 132 are connected by overlapping each other. Therefore, the plurality of support members 82 integrally move in the axial direction of the chuck body 81, move inward in the radial direction of the chuck body 81 in synchronization with each other, and are brought into a state in FIG. 19. On the other hand, when the plurality of support members 82 move toward the base end portion 81a of the chuck body 81, the plurality of support members 82 move in a direction separated from the center line O1. At this time, in the plurality of support members 82, the first connecting member 131 and the second connecting member 132 are connected by overlapping each other. Therefore, the plurality of support members 82 integrally move in the axial direction of the chuck body 81, move outward in the radial direction of the chuck body 81 in synchronization with each other, and are brought into a state in FIG. 20.

That is, as illustrated in FIG. 18, in a state where the pushing plate 75 presses the plurality of support members 82 in the direction Oa, when the chuck 50 moves in the direction Oa which is the insertion direction into the paper tube R1, the receiving surface 106 of the plurality of support members 82 comes into contact with and presses the end surface of the paper tube R1. When the center line O1 of the chuck 50 and the center line O2 of the paper roll R deviate from each other at this time, any first receiving surface 106a of the plurality of support members 82 does not abut on the end surface of the paper tube R1, and a gap is generated.

When the chuck 50 continues to move in the direction Oa, the support member 82 in which the receiving surface 106 abuts on the end surface of the paper tube R1 receives the pressing force from the paper tube R1, and moves in the direction Ob. At this time, all of the plurality of support members 82 are connected by the first connecting member 131 and the second connecting member 132. Therefore, the plurality of support members 82 move in the direction Ob in synchronization with each other. That is, the support member 82 in which the receiving surface 106 does not abut on the end surface of the paper tube R1 also moves in the direction Ob by the first connecting member 131 and the second connecting member 132. In addition, at this time, the plurality of support members 82 move outward in the radial direction of the chuck 50 while moving in the direction Ob, and the support surfaces 107 moves close to the inner peripheral surface of the paper tube R1.

When the chuck 50 continues to further move in the direction Oa, the plurality of support members 82 move outward in the radial direction while moving in the direction Ob, and the support surface 107 comes into contact with the inner peripheral surface of the paper tube R1. At this time, since the plurality of support members 82 uniformly move the respective support surfaces 107 outward in the radial direction, the support surface 107 presses the inner peripheral surface of the paper tube R1, and correct a position of the paper roll R. That is, the paper roll R is pressed upward in the vertical direction by the plurality of support members 82 of the chuck 50, and the center (center line O2) substantially coincides with the center (center line O1) of the chuck 50.

When the chuck 50 supports the paper roll R, all of the receiving surfaces 106 of the plurality of support members 82 come into contact with the end surface of the paper tube R1, and all of the support surfaces 107 come into contact with the inner peripheral surface of the paper tube R1. The chuck 50 supports the paper roll R at a position where the center lines O1 and O2 coincide with each other. Therefore, the specific support member 82 does not damage the continuous paper R2 without biting into the paper roll R.

The shapes of the connecting members 131 and 132 are not limited to the above-described shapes. FIG. 21 is a front view illustrating a modification example of the chuck. In order to facilitate understanding of the shape of the chuck, FIG. 21 illustrates the stopper portion 93 by using a two-dot chain line.

As illustrated in FIG. 21, the chuck 50 includes a first connecting member 133 and a second connecting member 134 as connecting members. The first connecting member 133 and the second connecting member 134 extend from the plurality of support members 82 in a direction intersecting the movement direction (direction of the center line O1) of the support member 82. The first connecting member 133 and the second connecting member 134 integrally move the plurality of support members 82 in the axial direction (direction of the center line O1) of the chuck body 81. At this time, the first connecting member 133 and the second connecting member 134 synchronously move the plurality of support members 82 in the radial direction of the chuck body 81.

Specifically, the first connecting member 133 extends from one side surface of each support member 82 along the circumferential direction of the chuck body 81. The second connecting member 134 extends from the other side surface of each support member 82 along the circumferential direction of the chuck body 81. The first connecting member 133 and the second connecting member 134 are plate members having a curved shape. The first connecting member 133 and the second connecting member 134 are disposed to deviate by a predetermined distance in the axial direction (direction of the center line O1) of the chuck body 81. A tip portion of the first connecting member 133 and a tip portion of the second connecting member 134 are disposed to overlap each other in the axial direction of the chuck body 81 between the adjacent support members 82.

The operations of the first connecting member 133 and the second connecting member 134 are the same as those of the first connecting member 131 and the second connecting member 132, and thus, description thereof will be omitted.

### Operational Effects of Present Embodiment

The paper roll support device according to a first aspect includes the pair of support arms 45 and 46 supported to be movable along the axial direction of the rotary shaft 43 of the frames 41 and 42, the screw shaft drive device (drive device) 48 that brings the pair of support arms 45 and 46 close to and separated from each other, and the pair of chucks 49 and 50 rotatably mounted on the tip portions of the pair of support arms 45 and 46 and configured to support the paper roll R. The chucks 49 and 50 include the chuck body 81 having a shape whose outer diameter decreases from the base end portion toward the tip portion and in which the plurality of guide grooves (guide portions) 94 along the axial direction are provided on the outer peripheral surface, and the plurality of support members 82 including the receiving surface (receiving portion) 106 supported to be movable by the plurality of guide grooves 94 and configured to come into contact with the end portion of the paper roll R, and a support surface (support portion) 107 configured to come into contact with the inner peripheral surface of the paper roll R. The paper roll support device further includes the pushing device (movement unit) 73 including the pushing plate (movement member) 75 configured to come into contact with the plurality of support members 82 and configured to move the plurality of support members 82 to the tip portion side by the pushing plate 75, and the force applying device that applies the force in the direction in which the plurality of support members 82 and the pushing plate 75 move close to each other.

According to the paper roll support device in the first aspect, when the pair of support arms 45 and 46 are moved in the direction in which the pair of support arms 45 and 46 move close to each other by the screw shaft drive device 48, the chucks 49 and 50 are inserted into the paper tube R1 of the paper roll R. In this manner, the paper roll R is supported to be integrally rotatable. At this time, the pushing device 73 presses the plurality of support members 82 via the pushing plate 75, and the force applying device applies the force in the direction in which the plurality of support members 82 and the pushing plate 75 move close to each other. Therefore, in the plurality of support members 82, the receiving surface 106 can appropriately press the end surface of the paper tube R1 of the paper roll R, and the support surface 107 can appropriately press the inner peripheral surface of the paper tube R1 of the paper roll R.

That is, when the center line O1 of the chuck 50 and the center line O2 of the paper roll R deviate from each other, any one receiving surface 106 of the plurality of support members 82 does not abut on the end surface of the paper tube R1, and a gap is generated. When the chuck 50 is inserted into the paper tube R1, the support member 82 in which the receiving surface 106 abuts on the end surface of the paper tube R1 moves along the guide groove 94. At this time, the support member 82 in which the receiving surface 106 does not abut on the end surface of the paper tube R1 also moves together with the pushing plate 75. The plurality of support members 82 move outward in the radial direction while moving in the axial direction of the chuck 50. Therefore, each support surface 107 uniformly presses the inner peripheral surface of the paper tube R1. Therefore, the paper roll R is supported in a state where the center (center line O2) coincides with the center (center line O1) of the chuck 50. As a result, it is possible to suppress damage to the paper roll R when the chucks 49 and 50 support the paper roll R, and it is possible to suppress the support of the paper roll R in a state where the centers (center lines O1 and O2) deviate from each other.

Furthermore, as the paper roll support device according to a second aspect, in the paper roll support device according to the first aspect, the force applied by the force applying device is lower than the support force with which the chucks 49 and 50 support the paper roll R after the support surface 107 comes into contact with the inner peripheral surface of the paper tube R1 of the paper roll R. In this manner, after the chucks 49 and 50 support the paper roll R, the pushing plate 75 can be appropriately separated from the plurality of support members 82, and the force applying device does not interfere with the rotation of the paper roll R.

Furthermore, as the paper roll support device according to a third aspect, in the paper roll support device according to the first aspect or the second aspect, the force applying device includes the suction device, and the suction device is provided in at least any one of the plurality of support members 82 and the pushing plate 75. In this manner, the plurality of support members 82 and the pushing plate 75 can be easily maintained in a state of being close to each other.

Furthermore, as the paper roll support device according to a fourth aspect, in the paper roll support device according to the third aspect, the suction device includes the magnets 121 and 122 provided in at least any one of the plurality of support members 82 and the pushing plate 75. In this manner, a configuration of the force applying device can be simplified.

Furthermore, as the paper roll support device according to a fifth aspect, in the paper roll support device according to the fourth aspect, the plurality of support members 82 include the flange portion 104 protruding outward in the radial direction of the chuck body 81, and the magnet 121 is disposed in the flange portion 104. In this manner, mounting performance of the magnet 121 on the support member 82 can be improved.

Furthermore, as the paper roll support device according to a sixth aspect, in the paper roll support device according to the fourth aspect, the opening 78 into which the chuck body 81 is freely inserted is formed in the pushing plate 75, and the magnet 122 is provided along the edge of the opening 78. In this manner, the number of the magnets 122 is reduced. Accordingly, manufacturing costs can be reduced, and the magnet 122 can be easily mounted on the pushing plate 75.

Furthermore, as the paper roll support device according to a seventh aspect, the paper roll support device according to the third aspect includes the suction portion 123 provided in the pushing plate 75, and the blower (suction device) 125 that generates the negative pressure to act on the suction portion 123, as the suction device. In this manner, the plurality of support members 82 can be appropriately suctioned to the pushing plate 75 by the suction portion 123.

Furthermore, as the paper roll support device according to an eighth aspect, the paper roll support device according to any one of the first aspect to the seventh aspect includes the first receiving surface 106a located on the center side and the tip portion side of the chuck body 81, and the second receiving surface 106b located on the outer peripheral portion side and the base end portion side of the chuck body 81 with respect to the first receiving surface 106a, as the receiving surface 106. In this manner, the paper rolls R having different inner diameters of the paper tubes can be supported.

Furthermore, as the paper roll support device according to a ninth aspect, in the paper roll support device according to any one of the first aspect to the eighth aspect, the pushing device 73 can press the pushing plate 75 against the plurality of support members 82, and is operated when the paper roll R is supported by the chucks 49 and 50 and when the chucks 49 and 50 are separated from the paper roll R. In this manner, when the paper roll R supported by the chucks 49 and 50 is rotated, the pushing plate 75 can be separated from the plurality of support members 82.

Furthermore, as the paper roll support device according to a tenth aspect, in the paper roll support device according to the ninth aspect, the pressing force with which the pushing plate 75 is pressed against the plurality of support members 82 by the pushing device 73 when the chucks 49 and 50 are separated from the paper roll R is equal to the pressing force when the paper roll R is supported by the chucks 49 and 50, or the pressing force when the chuck 50 is separated is higher. In this manner, when the chucks 49 and 50 are separated from the paper roll R, the chucks 49 and 50 can be easily pulled out by causing the pushing plate 75 to move the plurality of support members 82 with the pressing force.

The paper roll chuck according to an eleventh aspect includes the chuck body 81 having a shape whose outer diameter decreases from the base end portion toward the tip portion and in which the plurality of guide grooves (guide portions) 94 along the axial direction are provided on the outer peripheral surface, the plurality of support members 82 including the receiving surfaces (receiving portions) 106 supported to be movable by the plurality of guide grooves 94 and configured to come into contact with the end portion of the paper roll R, and the support surface (support portion) 107 configured to come into contact with the inner peripheral surface of the paper roll R, and the plurality of connecting members 131, 132, 133, and 134 extending from the plurality of support members 82 in the direction intersecting the movement direction of the support member 82, integrally moving the plurality of support members 82 in the axial direction of the chuck body 81, and synchronously moving the plurality of support members 82 in the radial direction of the chuck body 81.

According to the roll chuck in the eleventh aspect, the chucks 49 and 50 are inserted into the paper tube R1 of the paper roll R. In this manner, the paper roll R is supported to be integrally rotatable. When the center line O1 of the chuck 50 and the center line O2 of the paper roll R deviate from each other, any receiving surface 106 of the plurality of support members 82 does not abut on the end surface of the paper tube R1, and a gap is generated. When the chuck 50 is inserted into the paper tube R1, the support member 82 in which the receiving surface 106 abuts on the end surface of the paper tube R1 moves along the guide groove 94. At this time, the support member 82 in which the receiving surface 106 does not abut on the end surface of the paper tube R1 by the connecting members 131, 132, 133, and 134 also moves together with the pushing plate 75. The plurality of support members 82 move outward in the radial direction while moving in the axial direction of the chuck 50. Therefore, each support surface 107 uniformly presses the inner peripheral surface of the paper tube R1. Therefore, the paper roll R is supported in a state where the center (center line O2) substantially coincides with the center (center line O1) of the chuck 50. As a result, it is possible to suppress damage to the paper roll R when the chucks 49 and 50 support the paper roll R, and it is possible to suppress the support of the paper roll R in a state where the centers (center lines O1 and O2) deviate from each other.

Furthermore, as the paper roll chuck according to a twelfth aspect, the paper roll support device according to the eleventh aspect includes the first connecting members 131 and 133 provided on one side portion of the support member 82, and the second connecting members 132 and 134 provided on the other side portion of the support member 82 and disposed to deviate from the first connecting members 131 and 133 in the axial direction of the chuck body 81. In the adjacent support members 82, the first connecting members 131 and 133 and the second connecting members 132 and 134 are disposed to overlap each other in the axial direction of the chuck body 81. In this manner, the plurality of support members 82 can be appropriately moved in synchronization.

The corrugating machine (corrugated board manufacturing apparatus) 10 according to a thirteenth aspect includes the paper roll support devices 40A and 40B according to the first to tenth aspects, which support the paper roll of the bottom liner (first liner) A and the paper roll of the top liner (second liner) C, and the paper roll of the paper tube serving as the medium B, the single facer 15 that manufactures the single-faced web D by bonding the top liner C to the corrugated medium B, and the double facer that manufactures the double-faced web by bonding the bottom liner (first liner) A to the medium side in the single-faced web D. In this manner, the paper roll support devices 40A and 40B can suppress damage to the paper roll R when the chuck 49 or 50 supports the paper roll R, and can suppress the support of the paper roll R in a state where the centers (center lines O1 and O2) deviate from each other.

In the above-described embodiment, the configuration of the paper roll support devices 40A and 40B and the shape of the chucks 49 and 50 may be appropriately set depending on the paper roll R to be used, and are not limited to the examples described in the embodiments.

### Reference Signs List

10: corrugating machine (corrugated board manufacturing apparatus)
11: mill roll stand
12: preheater
13: mill roll stand
14: preheater
15: single facer
16: bridge
17: mill roll stand
18: preheater
19: glue machine
20: double facer
21: rotary shear
22: slitter scorer
23: cutoff
24: defective sheet rejecting device
25: stacker
31, 32, 33, 34: preheating roll
40A, 40B: paper roll support device
41, 42: frame
43: rotary shaft (support shaft)
44: rotary shaft drive device
45, 46: support arm
45a, 46a: first support portion
45b, 46b: second support portion
47: screw shaft
48: screw shaft drive device (drive device)
49, 50: chuck (paper roll chuck)
51: key
52, 53: support hole
54, 55: key groove
56, 57: support members 56, 57
58, 59: screw portion
61: detection sensor
62: operation control panel (control device)
71: rotary shaft
72: connecting member
73: pushing device (movement unit)
74: air cylinder
75: pushing plate (movement member)
76: rod
77: connecting member
78: opening
81: chuck body
82: Support member
91: attachment portion
92: main body part
93: stopper portion
94: guide groove (guide portion)
96: connecting rod
101: moving portion
102: support portion
103: attachment support portion
104: flange portion
104a: side surface
104b: bottom surface
104c: recessed portion
106: receiving surface (receiving portion)
106a: first receiving surface (first receiving portion)
106b: second receiving surface (second receiving portion)
106c: inclined surface
107: support surface (support portion)
108: protrusion portion
111 switching device
112: air supply and discharge pipe
113: air supply source
114: flow regulator
115: control device
121, 122: magnet
123: suction portion
124: suction pipe
125: blower (suction device)
131, 133: first connecting member (connecting member)
132, 134: second connecting member (connecting member)
A: bottom liner (first liner)
B: medium
C: top liner (second liner)
D: single-faced web
E: continuous double-faced web
F: sheet-shaped double-faced web
R: paper roll
R1: paper tube
R2: continuous paper
O1, O2: center line

1. A paper roll support device comprising:
a pair of support arms supported to be movable along an axial direction of a support shaft of a frame;
a drive device that brings the pair of support arms close to and separated from each other; and
a pair of chucks rotatably mounted on tip portions of the pair of support arms and configured to support a paper roll,
wherein the chuck includes
a chuck body having a shape whose outer diameter decreases from a base end portion toward a tip portion and in which a plurality of guide portions along the axial direction are provided on an outer peripheral surface, and
a plurality of support members including a receiving portion supported to be movable by the plurality of guide portions and configured to come into contact with an end portion of the paper roll, and a support portion configured to come into contact with an inner peripheral surface of the paper roll, and
the paper roll support device further comprises a movement unit including a movement member configured to come into contact with the plurality of support members and configured to move the plurality of support members to a tip portion side by the movement member; and
a force applying device that applies a force in a direction in which the plurality of support members and the movement member move close to each other.

2. The paper roll support device according to claim 1,
wherein the force applied by the force applying device is lower than a support force with which the chuck supports the paper roll after the support portion comes into contact with the inner peripheral surface of the paper roll.

3. The paper roll support device according to claim 1,
wherein the force applying device includes a suction device, and the suction device is provided in at least any one of the plurality of support members and the movement member.

4. The paper roll support device according to claim 3,
wherein the suction device includes a magnet provided in at least any one of the plurality of support members and the movement member.

5. The paper roll support device according to claim 4,
wherein the plurality of support members include a flange portion protruding outward in a radial direction of the chuck body, and the magnet is disposed in the flange portion.

6. The paper roll support device according to claim 4,
wherein the movement member includes an opening into which the chuck body is feely inserted, and the magnet is provided along an edge of the opening.

7. The paper roll support device according to claim 3,
wherein the suction device includes a suction portion provided in the movement member, and a suction device that generates a negative pressure to act on the suction portion.

8. The paper roll support device according to claim 1,
wherein the receiving portion includes
a first receiving portion located on a center side and the tip portion side of the chuck body, and
a second receiving portion located on an outer peripheral portion side and a base end portion side of the chuck body with respect to the first receiving portion.

9. The paper roll support device according to claim 1,
wherein the movement unit is configured to press the movement member against the plurality of support members, and is operated when the paper roll is supported by the chuck and when the chuck is separated from the paper roll.

10. The paper roll support device according to claim 9,
wherein a pressing force with which the movement member is pressed against the plurality of support members by the movement unit when the chuck is separated from the paper roll is equal to a pressing force when the paper roll is supported by the chuck, or the pressing force when the chuck is separated from the paper roll is higher.

11. A paper roll chuck comprising:
a chuck body having a shape whose outer diameter decreases from a base end portion toward a tip portion and in which a plurality of guide portions along an axial direction are provided on an outer peripheral surface;
a plurality of support members including a receiving portion supported to be movable by the plurality of guide portions and configured to come into contact with an end portion of the paper roll, and a support portion configured to come into contact with an inner peripheral surface of the paper roll; and
a plurality of connecting members extending from the plurality of support members in a direction intersecting a movement direction of the support member, integrally moving the plurality of support members in the axial direction of the chuck body, and synchronously moving the plurality of support members in a radial direction of the chuck body.

12. The paper roll chuck according to claim 11,
wherein the connecting member includes
a first connecting member provided on one side portion of the support member, and
a second connecting member provided on the other side portion of the support member and disposed to deviate from the first connecting member in the axial direction of the chuck body, and
in the adjacent support members, the first connecting member and the second connecting member are disposed to overlap each other in the axial direction of the chuck body.

13. A corrugated board manufacturing apparatus comprising:
the paper roll support device according to claim 1, which supports a paper roll of a first liner, a paper roll of a second liner, and a paper roll of a paper tube serving as a medium;
a single facer that manufactures a single-faced web by bonding the second liner to a corrugated medium; and
a double facer that manufactures a corrugated board by bonding the first liner to a medium side in the single-faced web.
